(19) United States
(12) Patent Application Publication
(10) Pub. No.: US 2005/0059567 A1
(43) Pub. Date: Mar. 17, 2005

(54) Methods of formulating enzyme cocktails, enzyme cocktails for the removal of egg-based and grass-based stains and/or soils, compositions and products comprising same

(75) Inventors: Michael Stanford Showell, Cincinnati, OH (US); Hiroshi Oh, Cincinnati, OH (US); Anna Vadimovna Radomyselski, Hamilton, OH (US); Alison Lesley Main, Tyne & Wear (GB); Anju Deepali Massey Brooker, Newcastle Upon Tyne (GB); Andrew Paul Nelson, Newcastle Upon Tyne (GB); Yiping Sun, West Chester, OH (US); William Merdia Begley, Tipp City, OH (US); Larry Anthony Smith, Cincinnati, OH (US); Richard Lee Walter JR., Hamilton, OH (US); Marlene Jan Mekel, Hamilton, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/660,312

(22) Filed: Sep. 11, 2003

(51) Int. Cl. C11D 3/00

(52) U.S. Cl. 510/392

(57) ABSTRACT

Methods of formulating enzyme cocktails based on the presence of enzyme-hydrolysable components in a target stain and/or soil. More specifically, the formulation of an enzyme cocktail comprising a specific enzyme for each component in a target stain and/or soil, optionally wherein each enzyme is incorporated at a level corresponding to the level of an enzyme-hydrolysable component in said target stain and/or soil. Further, enzyme cocktails for removing egg-based and grass-based stains, optionally formulated in accordance with the methods disclosed herein. Moreover, compositions and products comprising the enzyme cocktails disclosed herein and methods of using same.

### FIELD OF THE INVENTION

The present invention relates to methods of formulating enzyme cocktails. Particularly, the enzyme cocktails of the present invention are formulated to include a specific enzyme for each enzyme-hydrolysable component in a target stain and/or soil, optionally wherein each enzyme is incorporated in an amount corresponding to the level of an enzyme-hydrolysable component in said target stain and/or soil. The present invention further relates to enzyme cocktails, formulated in accordance with the present methods, for the removal of egg-based and grass-based stains and/or soils, as well as compositions and products comprising same.

### BACKGROUND OF THE INVENTION

The enzyme art continues to evolve, as evidenced by the introduction of many, diversified products—each of which incorporates one or more enzymes to achieve a purported objective. Indeed, enzymes are now widely employed in the general areas of fabric care, home care (e.g., dish care, hard surface care), beauty care and the like. As a result of the continued research and development in the area, the number of enzymes associated with novel nucleotide sequences has diminished. Consequently, many of those skilled in the art have now focused their efforts on the identification of enzyme cocktails, or combinations of two or more enzymes, to achieve synergistic (and novel) hydrolysis benefits for a target stain and/or soil. The individual enzymes employed in such cocktails, however, are typically known.

This renewed research in the realm of enzyme cocktails has resulted in the identification of several properties thereto related. For example, it has previously been disclosed in the art that the employment of two or more proteases, provides increased performance benefits in relation to the employment of a single protease incorporated at the same level against the same target stain and/or soil. Those of skill in the art have generally attributed the ability of contemporary enzyme cocktails to deliver equal or greater performance benefits in relation to single enzymes incorporated at similar levels, to some synergy exhibited via their combination. However, those of skill in the art have yet to articulate the precise basis to which any perceived synergy is attributable.

Actually, in identifying candidate enzymes for inclusion into a subject enzyme cocktail, those of skill in the art have generally employed a rather unselective technique of discovery. Namely, enzyme technologists typically engage in the formulation of enzyme cocktails by first identifying a target stain and/or soil for which removal via enzyme hydrolysis is desired. Technologists then identify all known enzymes that are believed to convey some hydrolysis benefits against the target stain and/or soil under consideration. Combinations of single enzymes believed to convey hydrolysis benefits against the target stain and/or soil when employed singularly are then tested against the target stain and/or soil to determine if said single enzymes exhibit synergistic benefits when employed in combination. After having formulated and tested significant numbers of enzyme combinations, researchers can often draw some conclusions as to the most effective enzyme combination for each target stain and/or soil under consideration.

Nevertheless, there exist several disadvantages in use of contemporary approaches to enzyme cocktail formulation. First, the identification of a suitable combination of enzymes using the conventional approach is directly related to, and limited by, the initial selection of single, candidate enzymes believed to convey hydrolysis benefits against the target stain and/or soil. Thus, if a single enzyme adapted to hydrolyze a specific (and possibly abundant) component of the target stain and/or soil is not included in the initial selection step, then said enzyme will be unduly excluded from the desired cocktail—thereby adversely affecting the performance benefits of any resultant cocktail. Further, use of the contemporary approach for formulation of enzyme cocktails is often expensive and time consuming. Indeed, significant testing must be conducted for each enzyme cocktail (often for each enzyme) to determine the existence of any synergistic benefits. Technologists must then review the results of each test and attempt to correlate any observable differences between use of a given enzyme cocktail against a target stain and/or soil and use of the enzymes that comprise said cocktail, individually. Finally, after having conducted considerable research and testing, technologists are often unable to identify any combination of enzymes that provides significantly better hydrolysis benefits for a target stain and/or soil than the use of individual enzymes and/or known enzyme cocktails against the same stain and/or soil.

Thus, there remains a substantial need in the art to identify a method for enzyme cocktail formulation that is based more closely upon the actual composition of enzyme-hydrolysable components in a target stain and/or soil, rather than the unsystematic mode of examination conventionally employed in the art. Such a method would at least partially alleviate the need to test multiple enzymes and combinations in attempts to identify synergy. Further, a method of formulating an enzyme cocktail based more closely upon the composition of enzyme-hydrolysable components in a target stain and/or soil would likely result in the formulation of an enzyme cocktail that is better adapted to hydrolyze the target stain and/or soil under consideration. Conceptually, it would be predicted that an enzyme cocktail comprising a particular enzyme for each enzyme-hydrolysable component in a target stain and/or soil, optionally incorporated in a corresponding level to each component, would provide better performance benefits against the target stain and/or soil then any other enzyme combination.

Moreover, there remains a substantial need in the art to identify and deploy enzyme cocktails for the removal of particularly cumbersome stains or soils. Egg-based stains and/or soils, for example, continue to present a significant dilemma for enzyme technologists and consumers alike. Despite the disclosure and/or commercialization of numerous cocktails purportedly adapted to remove egg-based stains or soils, consumers continue to struggle to eradicate such stains or soils from dishware, fabric, hard surfaces and the like. Similar difficulties have been experienced in the formulation and use of enzyme cocktails for the removal of grass-based stains or soils—despite the fact that many such cocktails have been identified and/or commercialized.

### SUMMARY OF THE INVENTION

The present invention addresses and resolves all of the quandaries associated with contemporary approaches to novel enzyme cocktail discovery and formulation. Indeed, the present invention relates to methods for enzyme cocktail formulation that are based more closely upon the actual composition of a target stain and/or soil, rather than the extensive testing of enzyme cocktails comprised of enzymes that are believed to convey hydrolysis benefits against a target stain and/or soil when employed individually.

Thus, in accordance with a first aspect of the present invention, a method for formulating enzyme cocktails based upon the enzyme-hydrolysable composition of a target stain and/or soil is disclosed. Said method generally comprises the steps of: identifying a target stain and/or soil for which removal via enzyme hydrolysis is desired, identifying one or more enzymes adapted to hydrolyze each component of a target stain and/or soil; and incorporating one or more enzymes adapted to hydrolyze a corresponding component of a target stain and/or soil. In another aspect of the present invention, enzymes are incorporated into a subject enzyme cocktail in an amount corresponding to the level of a specific enzyme-hydrolysable component in a target stain and/or soil. In another aspect of the present invention, the resultant enzyme cocktail is tested against the target stain and/or soil to determine the level in which the enzyme cocktail is adapted to hydrolyze said stain and/or soil. In yet another aspect of the present invention, performance of the enzyme cocktail formulated in accordance with the methods disclosed herein is compared against use of individual enzymes or previously-disclosed enzyme cocktails against the same target stain and/or soil, when both the cocktail under consideration and the contemporary enzyme formulation are conveyed to the same stain and/or soil in corresponding amounts.

In accordance with another aspect of the present invention, enzyme cocktails are disclosed and claimed. In one aspect of the present invention, said cocktails are formulated in accordance with the method for enzyme cocktail formulation disclosed herein. In another aspect of the present invention, an enzyme cocktail for the removal of egg-based stains and/or soils is disclosed and claimed. Said cocktail generally incorporates a specific enzyme for each enzyme-hydrolysable component in a typical egg-based stain and/or soil, optionally in an amount corresponding to the level in which said enzyme-hydrolysable component is present in said egg-based stain and/or soil. In another aspect of the present invention, an enzyme cocktail for the removal of grass-based stains and/or soils is disclosed and claimed. Said cocktail, too, generally employs a specific enzyme for each enzyme-hydrolysable component in the grass-based stain and/or soil under consideration, optionally in an amount corresponding to the level in which said enzyme-hydrolysable component is present in said grass-based stain and/or soil.

In yet another aspect of the present invention, the enzyme cocktails disclosed herein are incorporated into one or more compositions and/or products. In one aspect of the present invention, an enzyme cocktail for the removal of egg-based stains and/or soils is incorporated into a detergent composition, adapted to remove egg-based stains from, for example, dishware, hard surfaces and/or fabric. In another aspect of the present invention, an enzyme cocktail for the removal of grass-based stains and/or soils is incorporated into a detergent composition, adapted to remove grass-based stains and/or soils from, for example, fabric, hard surfaces and the like. In yet another aspect of the present invention, enzyme cocktails formulated in accordance with the methods disclosed herein are incorporated into a product, consumer or otherwise, optionally for the provision of one or more ancillary enzyme hydrolysis benefits.

In yet still another aspect of the present invention, methods of using the enzyme cocktails disclosed herein, compositions comprising same and/or products comprising same are disclosed and claimed. Said methods generally comprise the steps of delivering and/or applying an enzyme cocktail onto a target stain and/or soil for which removal via enzyme hydrolysis is desired, and optionally, removing said enzyme cocktail following its delivery. The precise steps of each method will depend upon several factors including, but not limited to, the nature of the substrate comprising the target stain and/or soil for which removal via enzyme hydrolysis is desired, the nature of the enzyme(s) used in the subject enzyme cocktail and the needs and/or abilities of the formulator.

### DETAILED DESCRIPTION OF THE INVENTION

By the term “cocktail” or the phrase “enzyme cocktail,” it is intended that mixtures described by said terms comprise two or more enzymes.

By the phrase “adapted to hydrolyze,” it is intended that enzymes and/or enzyme cocktails described by said phrase are capable of hydrolyzing one or more enzyme-hydrolyzable components of a target stain and/or soil at a rate of at least about 0.1% of following standard enzymes: Savinase® for protease, Lipolase® for Lipase, Phospholipase A1®, A2®, B®, C®, and/or D® for Phospholipase, Pectinase® for Pectinase, Xyloglucanase® for hemi-cellulase, and Carezyme® for cellulase.

The term “Protease A” is intended to refer to the enzyme sequence described in U.S. RE 34,606 in FIGS. 1A, 1B, and 7, as well as at column 11, lines 11-37, the relevant portions of which are hereby incorporated by reference. Protease A is further described in U.S. Pat. No. 5,441,882, which is incorporated herein by reference.

The term “Protease B” is intended to refer to the enzyme sequence described in U.S. Pat. Nos. 5,955,340 and 5,700,676 in FIGS. 1A, 1B and 5, as well as Table 1, the relevant portions of which are hereby incorporated by reference. Protease B is further described in U.S. Pat. Nos. 5,310,675, RE34,606 and 5,441,882, all of which are incorporated herein by reference.

The term “Protease C” is intended to refer to the enzyme sequence described in U.S. Pat. Nos. 6,312,936 and 6,482,628 in FIGS. 1-3 [SEQ ID 3], as well as at column 25, line 12. Protease C is further described in U.S. Pat. Nos. 5,955,340, 5,310,675, RE34,606 and 5,700,676, all of which are incorporated herein by reference.

First Aspect: Method of Formulating Enzyme Cocktail

Thus, in accordance with a first aspect of the present invention, a method of formulating an enzyme cocktail is disclosed and claimed. In one aspect of the present invention, said method comprises the steps of: identifying a target stain and/or soil for which removal via enzyme hydrolysis is sought; examining the target stain and/or soil to determine the level in which each enzyme-hydrolysable component comprised therein is present; screening one or more enzymes to determine which individual enzymes demonstrate the highest activity against each enzyme-hydrolysable component in the target stain and/or soil; and incorporating one or more enzymes demonstrating the highest activity for each enzyme-hydrolysable component in the target stain and/or soil into said cocktail—optionally, in an amount corresponding to the level of presence of an enzyme-hydrolysable component in the target stain and/or soil.

Identification and examination of a target stain for which removal via enzyme hydrolysis is sought, presents a particularly important aspect of the formulation methods disclosed herein. Of course, the target stain and/or soil under consideration must comprise a suitable percentage of enzyme-hydrolysable components to be adapted for removal using the methods and cocktails disclosed herein. Without wishing to be bound by theory, it is believed that a target stain and/or soil suitable for removal using the methods and cocktails disclosed herein comprises at least about 10%, preferably at least about 15%, more preferably at least about 20%, of enzyme-hydrolysable components, based on the total percent of said target stain and/or soil. Compositional analysis of a target stain and/or soil should result in an approximate determination as to the presence and character of each, fundamental enzyme-hydrolysable component in said stain and/or soil. Without wishing to be bound be theory, it is believed that removal of each fundamental, enzyme-hydrolysable component in said stain and/or soil facilitates the removal of the entire target stain and/or soil. Upon hydrolysis of the major components, other enzymes incorporated into the subject cocktail may then complete the removal of the entire target stain and/or soil. Alternatively, and without wishing to be bound by theory, enzyme hydrolysis of the primary components in a target stain and/or soil is believed to minimize hindrance created by other non-enzymatic components of the target, and therefore, better facilitate the use of surfactants and other cleaning adjuncts in removal of the entire target stain and/or soil under consideration.

Upon determining the character and/or percent content of each enzyme-hydrolysable component in a target stain and/or soil in accordance with the present method, one or more enzymes can then be screened against each, primary enzyme-hydrolysable component in said target. Practitioners of the methods disclosed herein may then identify the individual enzymes exhibiting the highest levels of hydrolysis against each, primary enzyme-hydrolysable component in the target stain and/or soil. In another aspect of the present invention, two or more enzymes may be selected for use against each enzyme-hydrolysable component in a target stain and/or soil. Upon narrowing the selection of individual enzymes to those exhibiting the highest level of hydrolysis against each primary, enzyme-hydrolysable component in a target stain and/or soil, a practitioner may then formulate an enzyme cocktail in accordance with said selection. In yet another aspect of the present invention, the individual enzymes incorporated in the enzyme cocktails formulated in accordance with the present invention, are employed in a subject enzyme cocktail at a level corresponding to that in which each primary, enzyme-hydrolysable component in a target stain and/or soil is present.

Upon formulating an enzyme cocktail in accordance with the methods disclosed herein, the practitioner may then test the subject cocktail against the target stain and/or soil for which removal via enzyme-hydrolysis is desired. In another aspect of the present invention, the results of such testing may then be compared against the use of other individual enzymes and/or enzyme cocktails, incorporated in amounts corresponding to that of the formulated cocktail, to confirm that the cocktails formulated in accordance with the methods disclosed herein exhibit better enzyme-hydrolysis benefits in comparison to conventional enzymes and/or enzyme cocktails against the same target stain and/or soil.

Enzyme Cocktail for Removing Egg-Based Stains or Soils

In another aspect of the present invention, enzyme cocktails comprising two or more enzymes adapted to remove an egg-based stain and/or soil are disclosed. In one aspect of the present invention, enzyme cocktails for removing an egg-based stain and/or soil are formulated in accordance with the methods of enzyme cocktail formulation disclosed herein. Namely, in one aspect of the present invention, an enzyme cocktail for removing an egg-based stain is formulated by examining the egg-based stain and/or soil for which removal via enzyme hydrolysis is desired. Such examination results in the identification of each, primary enzyme-hydrolysable component in said target stain and/or soil. Multiple enzymes, employed individually and in combination, can then be tested against each, primary enzyme-hydrolysable component in said target stain and/or soil. Upon determining which enzymes exhibit the highest level of hydrolysis for against each enzyme-hydrolysable component in said egg-based stain and/or soil, the subject enzymes may then be incorporated into a cocktail, optionally in an amount corresponding to the level of a given, enzyme hydrolysable component in said egg-based stain and/or soil. In one aspect of the present invention, a single enzyme is incorporated into an enzyme cocktail—directed to a specific enzyme-hydrolysable component is said target stain and/or soil, in an amount corresponding to the level in which said enzyme-hydrolysable component is present in said target stain and/or soil. In yet another aspect of the present invention two or more enzymes directed to a single enzyme-hydrolysable component are incorporated into the subject enzyme cocktail.

It is important to understand that natural eggs are generally comprised of two major components—namely, an egg white and an egg yolk. It has been determined that both egg whites and egg yolks are typically and predominantly comprised of proteins. Without wishing to be bound by theory, it is believed that egg whites are comprised of the following proteins (in approximated levels of presence therein): ovalbumin (approximately 54% of total egg white protein composition); conalbumin (approximately 13% of total egg white protein composition); ovomucoid (approximately 11% of total egg white protein composition); lysozyme (approximately 3.5% of total egg white protein composition); globulmin (approximately 8% of total egg white protein composition); and ovomucin (approximately 1.5% of total egg white protein composition). It should be noted and underscored that the above composition levels are approximated and are not intended to limit the scope of the present invention. Other miscellaneous components, protein-based and otherwise, are believed to make up the remaining 9% of natural egg whites.

Moreover, it is important to note that lipids comprise approximately 30% of natural egg yolk. In turn, said lipids are comprised of about 66% triglycerides and about 28% phospholipids. Without wishing to be bound theory, egg yolks are also generally comprised of proteins—namely, vitellogenin I, vitellogenin II and vitellogenin III. Indeed, it is further postulated that vitelleogenin II, the major protein component of egg yolks is processed into lipovitellin I, lipovitellin II, phosvitin and YGP40. To reiterate, it should be underscored that the aforementioned compositional characteristics are in no way intended to limit the scope of the present invention. It should be appreciated that the precise content of both natural egg whites and egg yolks is dependent upon several factors, including, but not limited to: the source of the egg under consideration, the physical and/or chemical conditions to which the egg has been subjected and the instruments used to compositionally examine the egg in question. Yet, the above approximations are believed to constitute the fundamental, enzyme-hydrolysable components of a typical, natural egg.

Those skilled in the art will readily appreciate that the precise composition of an egg-based stain is dependent upon a consideration of other ingredients that are added to eggs in conventional egg-based foods. Typically, milk, for example, is used to make scrambled eggs. Thus, the composition of the various, enzyme-hydrolysable components of milk must be considered in the formulation of an enzyme cocktail for removal of scrambled egg-based stains and/or soils. Without wishing to be bound by theory, milk is believed to be comprised of the following proteins (in approximated levels thereof): α-S1 casein (approximately 30.6% of total milk protein composition); α-S2 casein (approximately 8% of total milk protein composition), β casein (approximately 30.8% of total milk protein composition); κ-casein (approximately 10.1% of total milk protein composition); a-lactalbumin whey protein (approximately 3.7% of total milk protein composition); b-lactoglobulin whey protein (approximately 9.8% of total milk protein composition); blood serum albumin whey protein (approximately 1.2% of total milk protein composition); immunoglobulin whey protein (approximately 2.1% of total milk protein composition); miscellaneous whey proteins (approximately 2.4% of total milk protein composition); and fat globule membrane proteins (approximately 1.2% of total milk protein composition). To reiterate, it should be noted and underscored that the aforementioned, approximated levels of milk protein composition are in no way intended to limit the scope of the present invention. Those skilled in the art will readily appreciate that the precise composition of enzyme-hydrolysable components present in milk is dependent upon several factors, including but not limited to, they fat content of milk (e.g. fat-free, 1% fat, 2% fat, 10% fat); physical and/or chemical conditions to which the milk is subjected (i.e. heat) and the like. The above approximations are only intended to enable the practitioner of the present methods, and formulator of the present cocktails, to incorporate the appropriate level of enzyme for each fundamental, enzyme-hydrolysable component in an egg-based stain and/or soil (which may include the enzyme-hydrolysable components of milk in the case of scrambled eggs).

It is clear that the abundance of enzyme-hydrolysable components in both egg and milk (which may be an ingredient in scrambled eggs) consists of proteins. Accordingly, the enzyme cocktails for removing egg-based stains and/or soils disclosed herein are generally directed to the employment of a combination of one or more proteases—each of which is adapted and directed to hydrolyze one or more specific protein in the target egg-based stain and/or soil. Thus, in accordance with one aspect of the present invention, a protease cocktail for removing an egg-based stain or soil is disclosed. Said cocktail comprises (a) from about 0.00001% to about 5%, preferably from about 0.0001% to about 0.5%, more preferably from about 0.0002% to about 0.1%, most preferably from about 0.001% to about 0.05%, by weight of pure active protein of a protease, based on the total weight of said enzyme cocktail, adapted to hydrolyze casein at a rate of at least at 0.1% of proteolytic activity of an Enzyme Standard, preferably at a level of at least about 1%, more preferably at least about 5%, most preferably at least about 10%. In one aspect of the present invention, Novozyme's commercially-available Savinase® is employed as an Enzyme Standard, against which the proteolytic activity of any protease believed to hydrolyze casein is measured to determine whether said protease is suitable for inclusion into the present cocktails.

In another aspect of the present invention, the enzyme cocktails disclosed herein for the removal of egg-based stains or soils further comprise from about 0.00001% to about 5%, preferably from about 0.0001% to about 0.5%, more preferably from about 0.0002% to about 0.1%, most preferably from about 0.001% to about 0.05%, by weight of pure active protein of a protease, based on the total weight of said enzyme cocktail, adapted to hydrolyze phosvitin and/or lipovitellin at a rate of at least about 0.1% of proteolytic activity of an Enzyme Standard, preferably at least about 1%, more preferably at least about 5%, most preferably at least about 10%. In one aspect of the present invention, Novozyme's commercially-available SAVINASE® is employed as an Enzyme Standard, against which the proteolytic activity of any protease believed to hydrolyze phosvitin and/or lipovitellin is measured to determine whether said protease is suitable for inclusion into the present cocktails.

In yet another aspect of the present invention, the enzyme cocktails disclosed herein for the removal of egg-based stains and/or soils further comprise from about 0.00001% to about 5%, preferably from about 0.0001% to about 0.5%, more preferably from about 0.0002% to about 0.1%, most preferably from about 0.001% to about 0.05%, by weight of pure active protein of a protease, based on the total weight of said enzyme cocktail, adapted to hydrolyze ovalbumin at a rate of at least about 0.1% of the proteolytic activity of an Enzyme Standard, preferably at least about 1%, more preferably at least about 5%, most preferably at least about 10%. In one aspect of the present invention, Novozymes' commercially-available Savinase® is employed as an Enzyme Standard, against which the proteolytic activity of any protease believed to hydrolyze ovalbumin is measured to determine whether said protease is suitable for inclusion into the present cocktails.

Suitable proteases for use in the context of the present invention, include, but certainly are not limited to, those available from Novozymes (including Savinase®, Alcalase®, Esperase®, Ovozyme®, Everlase®, Neutrase®, Durazyme®, Pyrase®, Flavourzyme®); those available from Genencor International (including Propernase®, Purafect® Protease A, Protease B, Protease C); those available from Sigma (including Elastase®, Protease V8®, Pepsin®, Papain®, Bromelain®, Proteinase K®); those available from Biozyme Laboratories (including Elastase®); and any other available metallo, acidic, neutral and/or alkaline protease.

In yet another aspect of the present invention, lipase is further incorporated into an enzyme cocktail for the removal of egg-based stains and/or soils. Said cocktail comprises (b) from about 0.00001% to about 5%, preferably from about 0.0001% to about 0.5%, more preferably from about 0.0002% to about 0.1%, most preferably from about 0.001% to about 0.05%, by weight of pure active protein of a lipase, based on the total weight of the enzyme cocktail, adapted to hydrolyze triglycerides and/or diglycerides at a rate of at least about 0.1% of hydrolysis activity of an Enzyme Standard, preferably about at a rate of at least about 1%, more preferably at least about 5%, most preferably at least about 10%. In one aspect of the present invention, Novozymes' commercially-available Lipolase® is employed as an Enzyme Standard, against which the activity of any lipase believed to hydrolyze triglycerides and/or diglycerides is measured to determine whether said lipase is suitable for inclusion into the present cocktails. Suitable lipases (and/or esterases) for use in the context of the present invention include, but certainly are not limited to, those available from Novozymes (including Lipase®, Lipolase®, Lipolase Ultra®, Lipex®, Palatase®) and any other available neutral and/or alkaline Lipase.

In yet another aspect of the present invention, phospholipase is further incorporated into an enzyme cocktail for the removal of egg-based stains and/or soils. Said cocktail comprises from about 0.00001% to about 5%, preferably from about 0.0001% to about 0.5%, more preferably from about 0.0002% to about 0.1%, most preferably from about 0.001% to about 0.05%, by weight of pure active protein of a phospholipase, based on the total weight of enzyme cocktail, adapted to hydrolyze Phosphatidyl choline and/or Lysophosphatidyl choline at a rate of at least about 0.1% of hydrolysis activity of an Enzyme Standard (preferably at least about 1%, more preferably at least about 5%, most preferably at least about 10%. In one aspect of the present invention, Novozymes' commercially-available Phospholipase A1®, A2®, B®, C® and/or D® is employed as an Enzyme Standard, against which the activity of a phospholipase believed to hydrolyze Phosphatidyl choline and/or Lysophosphatidyl choline is measured to determine whether said phospholipase is suitable for inclusion into the present enzyme cocktails. Suitable phospholipases for use in the context of the present invention include those available from Novozymes (including phospholipase); those available from Genencor International (phospholipase); those available from Sigma (including Phospholipase A®, Phospholipase C®); and any other available neutral and/or alkaline phospholipase. In yet another aspect of the present invention, a ratio between any two of said enzymes is from about 1000:1 to about 1:1000, preferably from about 500:1 to about 1:500, more preferably from about 100:1 to about 100:1, most preferably from about 50:1 to about 1:50.

Those skilled in the art will readily appreciate that the precise composition of the enzyme cocktails disclosed herein will depend upon several factors, including but not limited to: the precise composition of a target egg-based stain and/or soil; the physical and/or chemical conditions to which a target egg-based stain and/or soil has been subjected; the medium through which delivery of the present enzyme cocktails to a target stain and/or soil is envisioned; and the needs and/or abilities of the formulator. Accordingly, the present invention further seeks to encompass enzyme cocktails for removing target egg-based stains or soils, optionally formulated in accordance with the methods disclosed herein, the precise enzyme content of which may be altered depending upon the composition of a given egg-based stain and/or soil.

Enzyme Cocktail for Removing Grass-Based Stains or Soils

In yet another aspect of the present invention, enzyme cocktails comprising two or more enzymes for the removal of grass-based target stains and/or soils are disclosed and claimed. In one aspect of the present invention, the enzyme cocktail for removing grass-based stains and/or soils is formulated via use of the method of formulation disclosed herein. Namely, in one aspect, the enzyme cocktail is formulated on the basis of the nature and content of each, primary enzyme-hydrolysable component in a grass-based target stain and/or soil. Without wishing to be bound by theory, it is believed that grass-based stains and or soils are generally comprised of chlorophyll, protein, carbohydrates and lipids.

Indeed, thorough examination of typical grass-based stains and/or soils reveals that chlorophyll, β-Carotene and other pigments are present as a complex with chlorophyll binding proteins (e.g. CP47, 43, 29, 27, 24)) inside the grass cell. Approximately four layers of various enzyme-hydrolysable components further envelop said complex. Namely, the chlorophyll is covered by a cell wall comprising cellulose, hemicellulose, xylans, xyloglucans, pectins, lignins and proteins. The chlorophyll of grass-based stains or soils is further shrouded by a chloroplast membrane comprising lipids (characterized by sterol and its corresponding esters) and proteins. The chlorophyll of grass-based stains or soils is also covered by stroma. Stroma is the site of CO₂ fixation and protein synthesis in a grass cell. The stroma of grass cells is generally comprised of ribosomes, ATP synthase, metal ions, phosphoglucose, starch and protein. Finally, a thylakoids membrane, comprising glycolipids, phospholipids, triglycerides, fatty acids and proteins, envelops the chlorophyll and other pigments.

Based on the total of all enzyme-hydrolysable components in a grass cell, it is believed that the natural grass cell is comprised of approximately 80% carbohydrates, approximately 10% proteins and approximately 3% lipids. To reiterate, it is not intended that the present methods and/or cocktails be limited by the above approximation of the composition of grass cells. Rather, the aforementioned approximations are intended to serve as a basis upon which practitioners may engage in formulation of an enzyme cocktail for removing a grass-based target stain and/or soil, in accordance with the present invention.

Thus, in one aspect of the present invention, a protease cocktail for the removal of grass-based stains and/or soils is disclosed. In one aspect of the present invention, said protease cocktail comprises: a protease adapted to hydrolyze D-ribulose 1,5-diphosphate carboxylase at a rate of at least about 0.1% proteolytic activity per mg of active protein, of an Enzyme Standard, preferably at least about 1%, more preferably at least about 5%, most preferably at least about 10%; a protease adapted to hydrolyze one or more chlorophyll-binding proteins at a rate of at least about 0.1% proteolytic activity per mg of active protein, of an Enzyme Standard, preferably at least about 1%, more preferably at least about 5%, most preferably at least about 10%; and a protease adapted to hydrolyze ATP synthase at a rate of at least about 0.1% proteolytic activity per mg of active protein, of an Enzyme Standard, preferably at least about 1%, more preferably at least about 5%, most preferably at least about 10%. In another aspect of the present invention, Novozyme's commercially-available Savinase® is employed as an Enzyme Standard, against which the proteolytic activity of a protease believed to hydrolyze a component of a grass-based stain and/or soil is measured to determine whether said protease is suitable for inclusion into the present cocktails. In yet still another aspect of the present invention, the ratio between any two of the aforementioned proteases is from about 1000:1 to about 1:1000, preferably from about 500:1 to about 1:500, more preferably from about 100:1 to about 100:1, most preferably from about 50:1 to about 1:50. In yet still another aspect of the present invention, chlorophyll-binding proteins for purposes of the above-described cocktail are selected from the group consisting of CP47, CP43, CP29, CP27, CP24 and combinations thereof.

In another aspect of the present invention, an enzyme cocktail adapted to remove a grass-based stain and/or soil is disclosed. In one aspect of the present invention, said cocktail comprises: a lipase adapted to hydrolyze triglyceride and/or diglyceride at a rate of at least about 0.1% activity per mg of active protein, of an Enzyme Standard, preferably at least about 1%, more preferably at least about 5%, most preferably at least about 10%; a pectinase adapted to hydrolyze poly-D-galacturonic acid methyl ester at a rate of at least about 0.1% activity per mg of active protein, of an Enzyme Standard, preferably at least about 1%, more preferably at least about 5%, most preferably at least about 10%; a hemicellulase adapted to hydrolyze hemicellulose, xyloglucans, xylans and combinations thereof at a rate of at least about 0.1% activity per mg of active protein, of an Enzyme Standard, preferably at least about 1%, more preferably at least about 5%, most preferably at least about 10%; and a cellulase adapted to hydrolyze cellulose and/or carboxy methyl cellulose at a rate of at least about 0.1% activity per mg of active protein, of an Enzyme Standard, preferably at least about 1%, more preferably at least about 5%, most preferably at least about 10%. In one aspect of the present invention, Novozyme's commercially-available Lipolase® is employed as an Enzyme Standard, against which the enzymatic activity of a lipase believed to hydrolyze a component of a grass-based stain and/or soil is measured to determine whether said lipase is suitable for inclusion into the present cocktails. In another aspect of the present invention, Novozyme's commercially-available Pectinase® is employed as an Enzyme Standard, against which the activity of a pectinase believed to hydrolyze a component of a grass-based stain and/or soil is measured to determine whether said pectinase is suitable for inclusion into the present cocktails. In another aspect of the present invention, Novozyme's commercially-available Xyloglucanse® is employed as an Enzyme Standard, against which the activity of a hemicellulase believed to hydrolyze one or more components of a grass-based stain and/or soil is measured to determine whether said hemicellulase is suitable for inclusion into the present cocktails. In yet another aspect of the present invention, Novozyme's commercially-available Carezyme® is employed as an Enzyme Standard, against which the activity of a cellulase believed to hydrolyze one or more components of a grass-based stain and/or soil is measured to determine whether said cellulase is suitable for inclusion herein. In yet still another aspect of the present invention, the cocktail described in the instant paragraph further comprises a protease cocktail in accordance with the preceding paragraph, for the removal of a grass-based stain and/or soil.

In yet another aspect of the present invention, an enzyme cocktail for removing a grass-based target stain and/or soil is disclosed. In one aspect, this cocktail comprises (a) one or more enzymes for the hydrolysis of carbohydrate at a level of from about 0.00001% to about 5%, preferably from about 0.0001% to about 0.5%, more preferably from about 0.0002% to about 0.1%, most preferably from about 0.001% to about 0.05%, by weight of pure active protein of a carbohydrase, based on the total weight of said enzyme cocktail; (b) one or more enzymes for the hydrolysis of protein at a level of from about 0.00001% to about 5%, preferably from about 0.0001% to about 0.5%, more preferably from about 0.0002% to about 0.1%, most preferably from about 0.001% to about 0.05%, by weight of pure active protein of a protease, based on the total weight of said enzyme cocktail; and (c) one or more enzymes for the hydrolysis of lipid at a level of from 0.00001% to about 5%, preferably from about 0.0001% to about 0.1%, more preferably from about 0.0002% to about 0.03%, most preferably from about 0.001% to about 0.05%, by weight of pure active protein of a lipase, based on the total weight of said enzyme cocktail.

Suitable carbohydrases for use in the context of the present invention include those available from Novozymes (including Amylase®, Termamyl®, Duramyl®, Natalase®, Xyloglucanase®, Pectate Lyase®, Dextranase®, Xylonase®, β-Glucanase®, Mannaway®, Hemicelluloses®, Cellulase®); those available from Genencor (including Amylase®, Hemicelluloses®, Cellulase®); and any other available carbohydrases. Suitable Protease for use in the context of the present invention include those available from Novozymes (including Savinase®, Alcalase®, Esperase®, Ovozyme®, Everlase®, Neutrase®, Durazyme®, Pyrase®, Flavourzyme®); those available from Genencor International (including Propernase®, Protease A, Protease B, Protease C, Purafect®); those available from Sigma (including Elastase®, Protease V8®, Pepsin®, Papain®, Bromelain®, Proteinase K®); Biozyme Laboratories (including Elastase®); and any other available metallo, acidic, neutral and/or alkaline protease. Suitable lipases (or esterase) for use in the context of the present invention include those available from Novozymes (including Lipase®, Lipolase®, Lipolase Ultra®, Lipex®, Palatase®); and any other available neutral and/or alkaline Lipase. In yet another aspect of the present invention, a ratio between any two of the aforementioned enzymes is from about 1000:1 to about 1:1000, preferably from about 500:1 to about 1:500, more preferably from about 100:1 to about 100:1, most preferably from about 50:1 to about 1:50.

Those skilled in the art will readily appreciate that the composition of the present enzyme cocktails for removing grass-based stains or soils will be dependent upon several factors, including but not limited to: the precise composition of the target grass stain and/or soil under consideration, the physical and/or chemical conditions to which a target grass-based stain and/or soil has been subjected; the medium through which delivery of the present enzyme cocktails to a target grass-based stain and/or soil is envisioned; and the needs and/or abilities of the formulator. Accordingly, the present invention further seeks to encompass enzyme cocktails for removing target grass-based stains or soils, formulated in accordance with the methods disclosed herein, the precise enzyme content of which may be altered depending upon the exact composition of a given grass-based stain and/or soil.

Enzyme Cocktail Formulation

Those skilled in the art to which the present invention pertains will further appreciate that there exist several methods for formulating the present enzyme cocktails, once the process of identifying suitable enzymes for incorporation therein is complete. Indeed, in one aspect of the present invention, the enzyme cocktails of the present invention, adapted to remove egg-based and/or grass-based stains and/or soils, may be formulated employing the standard approach of co-enzyme granule and/or liquid formulation. A description of the steps associated with co-enzyme granule and/or liquid formulation of enzyme cocktails is found at pages 372-374 of “Industrial Enzymes and Their Application”, by Helmut Uhlig, PhD, JOHN WILEY & SONS, INC. 1998. Eygermans, P. J., “Preparation of enzymes in particulate from,” U.S. Pat. No. 3,801,463; Weber-Meyer, M., “Liquid cleaning composition containing stabilized enzymes: Protease,” U.S. Pat. No. 4,169,817; Win, M. H., Desalvo, W. A., and Kenney, E. J., “Enzymatic detergents,” U.S. Pat. No. 3,858,854, and De Rosier, T. A., “Method and Formulation for Stabilization of Enzymes”, WO 9800530, the relevant portions of which are hereby incorporated by reference.

In another aspect of the present invention, the egg-based and/or grass-based enzyme cocktails disclosed herein are formulated using a standard approach of single enzyme granule and/or liquid formulation. A description of the steps associated with single enzyme granule and/or liquid formulation of enzyme cocktails is found at pages 372-374, “Industrial Enzymes AND THEIR APPLICATION”, by Helmut Uhlig, PhD, JOHN WILEY & SONS, INC. 1998. Eygermans, P. J., “Preparation of enzymes in particulate from,” U.S. Pat. No. 3,801,463; Weber-Meyer, M., “Liquid cleaning composition containing stabilized enzymes: Protease,” U.S. Pat. No. 4,169,817; Win, M. H., Desalvo, W. A., and Kenney, E. J., “Enzymatic detergents,” U.S. Pat. No. 3,858,854., and De Rosier, T. A., “Method and Formulation for Stabilization of Enzymes”, WO 9800530, the relevant portions of which are hereby incorporated by reference.

Detergent Compositions and Products Comprising Enzyme Cocktails

In yet another aspect of the present invention, detergent compositions comprising the enzyme cocktails disclosed herein are disclosed and claimed. In one aspect of the present invention, a detergent composition comprising an enzyme cocktail for the removal of egg-based stains or soils is disclosed. When incorporated into detergent compositions in accordance with the present invention, the enzyme cocktails disclosed herein are present at a level of from 0.00001% to about 5%, preferably from about 0.0001% to about 0.5%, more preferably from about 0.0002% to about 0.1%, most preferably from about 0.001% to about 0.05%, by weight of pure active protein of an enzyme, based on the total weight of detergent composition.

In yet another aspect of the present invention, a detergent composition comprising enzyme-cocktail for the removal of a grass-based stain or soil is disclosed and claimed. In one aspect of the present invention, the enzyme cocktail for removing grass-based stains or soils is formulated for incorporation into the subject detergent compositions via employment of the method of formulation disclosed in the present application. In any event, the detergent compositions disclosed herein comprise an enzyme cocktail for the removal of grass-based stains or soils, at a level of from about 0.00001% to about 5%, preferably from about 0.0001% to about 0.5%, more preferably from about 0.0002% to about 0.1%, most preferably from about 0.001% to about 0.05%, by weight of pure active protein of an enzyme, based on the total weight of detergent composition. Those skilled in the art will readily appreciate that the precise level of enzyme cocktail for the removal of grass-based stains or soils incorporated into the present detergent compositions is dependent upon several factors, including but not limited to: the nature of the detergent composition in which incorporation of the enzyme cocktail is intended; the precise composition of the enzyme cocktail for which incorporation into a detergent composition is desired; the target stain or soil for which removal via enzyme hydrolysis is desired; and the needs and/or abilities of the formulator.

In another aspect of the present invention, the detergent compositions disclosed herein comprise one or more surfactants, non-limiting examples of which include nonionic, anionic, amphoteric, amphophilic, zwitterionic, cationic, semi-polar nonionic, and mixtures thereof. Nonlimiting examples of such surfactants are disclosed in U.S. Pat. Nos. 5,707,950 and 5,576,282, incorporated herein by reference. A typical listing of anionic, nonionic, amphoteric and zwitterionic classes, and species of these surfactants, is provided in U.S. Pat. No. 3,664,961 issued to Norris on May 23, 1972, and incorporated herein by reference. Nonlimiting examples of surfactants useful herein include the conventional C₈-C₁₈ alkyl ethoxylates and/or alcohol ethoxylates (AE), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, C₁₁-C₁₈ (linear) alkyl benzene sulfonates (LAS) and primary, secondary and random alkyl sulfates (AS and/or SAS), the C₁₀-C₁₈ alkyl alkoxy sulfates (AES), the C₁₀-C₁₈ alkyl polyglycosides and their corresponding sulfated polyglycosides (APG), C₁₂-C₁₈ alpha-sulfonated fatty acid esters, C₁₂-C₁₈ alkyl and alkyl phenol alkoxylates (especially ethoxylates and mixed ethoxy/propoxy), C₁₂-C₁₈ betaines and sulfobetaines (“sultaines”), C₁₀-C₁₈ amine oxides, alpha olefin sulfonates (AOS), alcohol ethoxy sulfates, sodium paraffin sulfonates, amido propyl amines, alkyl N-methyl glucamides, nitrilotriacetic acid (NTA), alkali metal salts of natural fatty acids and the like. Other conventional useful surfactants are listed in standard texts.

In yet another aspect of the present invention, the enzyme cocktail-comprising detergent compositions disclosed herein incorporate one or more conventional cleaning adjuncts for the conveyance of one or more performance and/or aesthetic benefits. While not essential for the purposes of the present invention, several conventional cleaning adjunct materials illustrated hereinafter are suitable for use in the present compositions and may be desirably incorporated in preferred embodiments of the present invention, for example to assist or enhance cleaning performance, for treatment of the substrate to be cleaned, or to modify the aesthetics of the present composition as is the case with perfumes, colorants, dyes or the like. The precise nature of these additional components, and levels of incorporation thereof, will depend on the physical form of the composition and the nature of the cleaning operation for which its use is intended.

Adjuncts suitable for incorporation into the enzyme cocktail-comprising detergent compositions of the present invention include, but certainly are not limited to: bleaching systems, enzyme stabilizers, builders, dispersants, soil release agents, chelating agents, suds suppressors, softening agents, dye transfer inhibition agents, non-phosphate builders, color speckles, silvercare, anti-tarnish and/or anti-corrosion agents, dyes, fillers, germicides, alkalinity sources, hydrotropes, anti-oxidants, perfumes, solubilizing agents, carriers, processing aids, pigments, and pH control agents as described in U.S. Pat. Nos. 5,705,464, 5,710,115, 5,698,504, 5,695,679, 5,686,014 and 5,646,101, all of which are incorporated herein by reference.

In another aspect of the present invention, the compositions disclosed herein will take the form of a detergent composition, particularly suitable for fabric and home care contexts. Such a detergent composition can take a variety of shapes and forms depending upon several factors, including but not limited to: the precise nature of the detergent composition comprising the enzyme cocktails disclosed herein; the precise composition of the subject enzyme cocktail for which inclusion into a detergent composition is desired; and the nature of the target stain and/or soil for which removal via enzyme hydrolysis is desired. Nevertheless, non-limiting examples of such detergent forms include: liquids, powders, agglomerates, pastes, tablets, bars, gels and/or or granules.

In yet another aspect of the present invention, products, consumer and otherwise, incorporating the enzyme cocktails disclosed herein are disclosed and claims. Indeed, the enzyme cocktails formulated in accordance with the methods disclosed herein may be incorporated into numerous products for the provision of one or more performance and/or aesthetic benefits. Said products may take a multitude of shapes and forms depending upon several factors, including but not limited to: the nature and/or intended purpose of the product, the enzyme cocktail for which incorporation into a product is desired, and the target stain and/or soil for which removal via use of the present products is desired. The below disclosure is not intended to limit the scope of the present invention, but rather, is simply intended to provide a person of skill in the art with some guidance as to available uses of the present invention. Indeed, the products disclosed herein can be adapted for a variety of purposes, including but not limited to, personal care, fabric care, home care and skin care.

Personal Care Products

Thus, in accordance with a first aspect of the present invention, personal care products comprising the enzyme cocktails formulated in accordance with the present invention are disclosed. Suitable personal care products comprising the enzyme cocktails formulated in accordance with the present invention, include, but are not limited to: hand soaps, hand sanitizers, body washes, mouth washes, toothpastes, shower gels, shampoos, body lotions, deodorants, nasal sprays and combinations thereof. In yet another aspect of the present invention, the personal care products disclosed herein take the form of a wipe product, particularly suitable for wiping or drying the face or hands. In such instance, the products comprising the enzyme cocktails formulated in accordance with the present invention are preferably embedded or impregnated into said wipe product. In yet still another aspect of the present invention, the personal care product disclosed herein takes the form of a tissue or towel, also suitable for wiping or drying the face or hands. In another aspect of the present invention, the personal care product takes the form of a feminine napkin and/or a diaper. In another aspect of the present invention, the personal care product takes the form of a first aid antiseptic for irritated, injured, or acne-affected skin and/or for pre or post surgical use.

Household Care Products

In another aspect of the present invention, the products comprising the enzyme cocktails formulated in accordance with the present invention are incorporated into one or more household care products. Indeed, suitable household care products for purposes of the present invention include, but are not limited to: hard surface cleaners, deodorizers, fabric care compositions, fabric cleaning compositions, manual dish detergents, automatic dish detergents, floor care compositions, kitchen cleaners or disinfectants, bathroom cleaners or disinfectants and combinations thereof. In another aspect of the present invention, the household care product takes the form of a wipe or towel, suitable for household cleaning and/or care. In yet another aspect of the present invention, the household care products disclosed herein comprise certain adjunct ingredients. Said adjuncts include, but certainly are not limited to: builders, bleaching agents, bleach activators, transitional metal bleach catalysts, oxygen transfer agents and precursors, soil release agents, clay soil removal and/or anti-redeposition agents, polymeric dispersing agents, brightener, polymeric dye transfer inhibiting agents, chelating agents, anti-foam agents, alkoxylated polycarboxylates, fabric softeners, perfumes, carriers, hydrotropes, processing aids, dyes or pigments, solvents for liquid formulations, solid fillers, detersive surfactants and combinations thereof.

Skin Care Products

In another preferred aspect of the present invention, the products comprising the enzyme cocktails formulated in accordance with the present invention are incorporated into a skin care product. In one aspect of the present invention, the skin care product incorporates a dermatologically acceptable carrier to facilitate safe transfer of the products comprising the enzyme cocktails formulated in accordance with the present invention to the desired area of the skin. In another aspect of the present invention, the skin care product of the present invention comprises certain adjunct ingredients. Said adjuncts include, but certainly are not limited to: antimicrobial and antifungal actives, surfactants, desquamation actives, anti-acne actives, anti-wrinkle actives, anti-atrophy actives, anti-oxidants, radical scavengers, chelators, flavonoids, anti-inflammatory agents, anti-cellulite agents, topical anesthetics, tanning actives, sunscreen actives, conditioning agents, thickening agents, detackifying agents, odor control agents, skin sensates, antiperspirants and mixtures thereof. Indeed, a complete description and examples of each of the aforementioned adjunct ingredients is set forth in U.S. Pat. No. 6,294,186, assigned to The Procter and Gamble Company, Cincinnati, Ohio and incorporated herein by reference.

Articles of Manufacture & Kits

Moreover, articles of manufacture comprising the products comprising the enzyme cocktails formulated in accordance with the present invention are intended for personal care, skin care and household care applications. The article of manufacture of the present invention encompasses one or more products as described hereinbefore that may be packaged in a container or dispenser with a set of instructions for the consumer. The article of manufacture of the present invention typically comprises (a) container or dispenser, (b) product and (c) set of instructions to apply said product to an appropriate substrate to convey one or more performance and/or aesthetic benefits. Containers and/or dispensers suitable for the article of manufacture of the present invention include, but are not limited to: PET bottles and tubs, flow-wrap pouches, foaming dispensers, spray dispensers and combinations thereof. To reiterate, the article of manufacture of the present invention further comprises a set of instructions in association with the container. By “in association with,” it is meant that the instructions are either directly printed on the container or dispenser itself or presented in a different fashion including, but not limited to: a brochure, print advertisement, electronic advertisement and/or verbal communication, so as to communicate the set of the instructions to a consumer of the article of manufacture.

The set of instructions typically comprise the instructions relating to the use of the product to apply the products comprising the enzyme cocktails formulated in accordance with the present invention onto a suitable substrate for which treatment via enzyme hydrolysis is sought. The set of instructions may further comprise the instruction to allow the enzyme cocktails formulated in accordance with the present invention to remain on the treated substrate. Nevertheless, the precise instructions included with the article of manufacture of the present invention will depend on the precise ingredients of the subject enzyme cocktail, the product for which the inclusion of instructions is desired and the substrate onto which application of the product is intended. In another aspect of the present invention, the instructions included in the present articles of manufacture coincide with the methods set forth in the “Methods of Using” section of the present disclosure.

Methods of Using Enzyme Cocktails, Compositions and Products Disclosed Herein

In another aspect of the present invention, methods of using the enzyme cocktails, compositions and products set forth herein are disclosed and claimed. In one aspect, methods of using an enzyme cocktail formulated in accordance with the method of formulation discussed herein are disclosed. This method generally involves the step of delivering the enzyme cocktail to a target stain and/or soil for which removal via enzyme hydrolysis is desired. In another aspect of the present invention, a method for removing an egg-based stain and/or soil using an enzyme cocktail formulated in accordance with the present disclosure is disclosed and claimed. This method, too, generally comprises the step of delivering an enzyme cocktail adapted to remove an egg-based stain and/or soil to a target, egg-based stain and/or soil for which removal via enzyme hydrolysis is desired. In yet another aspect of the present invention, a method for removing a grass-based stain and/or soil using an enzyme cocktail formulated in accordance with the present invention is disclosed and claimed. This method also comprises the general step of delivering an enzyme cocktail adapted to hydrolyze a grass-based stain and/or soil to a target, grass-based stain and/or soil for which removal via enzyme hydrolysis is desired.

In yet other aspects still, methods of using the enzyme cocktail-comprising compositions of the present invention to remove an enzyme-hydrolysable stain and/or soil are disclosed and claimed. Said methods, too, generally comprise the step of delivering an enzyme cocktail-containing detergent composition to an enzyme-hydrolysable stain and/or soil for which removal is desired. In another aspect of the present invention, a method for removing an egg-based stain and/or soil using the egg-based enzyme cocktail-comprising detergent compositions set forth herein is disclosed and claimed. Said method, too, generally comprises the step of delivering an egg-based enzyme cocktail-comprising detergent composition to an egg-based stain and/or soil for which removal is desired. In yet another aspect of the present invention, a method of removing a grass-based stain and/or soil using the grass-based enzyme cocktail-comprising detergent compositions discussed herein is disclosed and claimed. Said method also comprises, generally, the step of delivering a grass-based enzyme cocktail-comprising detergent composition to a grass-based stain and/or soil for which removal is sought.

In yet other aspects of the present invention, methods of using the products, consumer and otherwise, comprising the enzyme cocktails disclosed herein are disclosed and claimed. Said methods, too, generally comprises the step of applying the product incorporating an enzyme cocktail formulated in accordance with the present invention to a target stain and/or soil for which removal via enzyme hydrolysis is desired. Of course, a practitioner of the present invention will readily appreciate that the precise steps involved in the present methods is dependent upon several factors, including, but not limited to: the nature of the product comprising the enzyme cocktail formulated in accordance with the present invention, the composition of the enzyme cocktail formulated in said product and the target stain and/or soil for which removal via enzyme hydrolysis using the products disclosed herein is desired.

### PREPARATIVE EXAMPLES

### EX1: Protein Composition and Protease Specificity for Egg-based Stains and/or Soils

Multi-analytical tools were used to establish that different proteases are associated with different specificities against the various proteins found in egg-based stains and/or soils. This data clearly supports the claimed model of protease cocktail formulation for egg-based stain and/or soil removal. The results of this testing are included as follows:

Activity measurement using Hitachi 911 automatic spectrophotometer: Proteolytic enzymes react with dimethylcasein to produce amino acids which in turn react with trinitrobenzene sulfonic acid to give a colored complex. The intensity of the color, read at 420 nm, is proportional to the activity of the protease in the sample which is expressed in terms of the mg/ml (mg active in the ml of sample) protease activity calibrated with Savinase® standard. As an alternative activity measurement method, hydrolyzed peptide fragments of the protein substrate were determined by LC-MS with Time of Flight Detector. The intensity of the peptide fragment, is proportional to the activity of the protease in the enzyme sample. For Lipovitellin proteins, the substrate was incubated with 5 ppm of the protease in TRIS® buffer, and the intact protein and its hydrolyzed fragments were monitored by SDS-page assay. The intensity of the peptide fragment, is proportional to the activity of the protease in the enzyme sample.

| | | Best | |
|---|---|---|---|
| | Proteins Composition (%) | Protease | Analytical Method |
| Milk | α Casein (39) | Ovozyme | LC-MS, Hitachi 911 |
| | β Casein (31) | Esperase | LC-MS |
| | κ Casein (10) | | |
| | Whey Proteins (19) | | |
| | (Lactogalbulin/ | | |
| | Immunoglobulin) | | |
| Egg | | | |
| White: | Ovalbumin (54) | Esperase | LC-MS, Hitachi 911, |
| | Conalbumin (13) | | |
| | Ovomucoid (11) | | |
| | Globulins(8) | | |
| | Lysozyme (4) | | |
| | Ovomucin (2) | | |
| Yolk: | Lipovitellin (50) | Savinase | SDS-Page |
| | Phosvitin | Protease B | LC-MS. Hitachi 911 |

It was also confirmed that hydrophobic yolk proteins are the most resistant substrates to proteolytic attack. After 6 hours incubation of Lipovitellin with various proteases, it was observed that approximately half of the initial protein bands remained intact in SDS-page imaging. During the same treatment, other proteins from milk and egg white were completely digested within five to thirty minutes by the proteases tested.

### EX2: Identification of Enzyme Cocktail (protease and/or protease+Phospholipase) for Improved Egg-based Stain and/or Soil Removal Versus Benchmark in Auto Dish and Hand Dish Detergency Executions

A micro-washing test with 24 well plates was performed. Punch out stainless steel disks using hammer and punch. Weigh clean disks to determine initial weights. Prepare egg stains (see preparation protocol infra). Using syringe dispenser, dispense 50 uL of prepared egg onto each disk. Allow to dry at room temperature for 30 minutes, then bake in oven at 80° C. for 2 hours. Cool at room temperature. After soiling disks, weigh to obtain the soiled weights. Insert soiled disks into NUNCLON® 24 well polystyrene plate. Auto Dish washing product solution is prepared by thoroughly mixing the appropriate amount of ADW without Enzyme product (e.g. Gel—8000 ppm: Powder 4500 ppm), or Hand Dish detergent without enzyme product (e.g. 1200 ppm) into 1 L of 11 gpg water at 40° C. Hardness solution is prepared by mixing 188.57 g CaCl₂ 2H₂O and 86.92 g MgCl₂ 6H₂O into 1 L DI water. Add 2 mL of pre-warmed ADW solution at 55° C. to each cell. Add appropriate amount of enzyme to each cell. Treatments can run either six across with four duplicates, or four across with six duplicates. Seal the plate with film. Place plate in pre-warmed incubator/shaker and secure with flask clamps. Wash for 30 minutes at appropriate temperature (55° C. for Euro), 180 RPM. After wash, rinse by carefully dipping in bath of warm water three separate times. Remove disks from plate and dry in oven for 1 hour at 80° C. Once dry, weigh disks to obtain washed weights. Gravimetric evaluation resulting in approximate percent removal is calculated as follows:
% Removal=(soiled weight-washed weight)/(soiled weight-clean weight)×100 Removal Index=% Removal/% Removal by Benchmark Protease (Savinase®)
Scrambled Egg Preparation

Eggs for use in testing of the present enzyme cocktails and/or detergent compositions comprising same are prepared as follows: (1) Mix 100 mls of 10% fat milk with 3 whole eggs; (2) cook above mixture, stirring continuously, until slightly runny; (3) add another 40 mls milk, and blend the mixture with a hand mixture or blender on high until smooth, with no signs of going lumpy; and (4) allow egg mixture to cool to room temperature before soiling.

The performance profile indicated that Savinase and Protease B are well performing single proteases for auto dishwashing applications (ADW benchmark) and Protease A is a well-performing single protease for hand dish detergent applications (LDL benchmark), for the removal of egg-based stains and/or soils. Nevertheless, the use of a protease cocktail (e.g. Protease B+Esperase and/or Protease B+Ovozyme) exhibits significantly better performance benefits than any single protease against egg-based stains and/or soils. The protease cocktails exhibited greater than five times performance versus a Protease B benchmark in auto dishwashing applications (ADW) and Protease A benchmark in liquid detergent applications (LDL). These protease cocktail benefits have been confirmed in ADW full-scale washing machine test.

Preparation of egg stains using stainless steel slides (1×3 inch). (1) Measure out 140 mls of full fat milk. (2) 3 medium size eggs (white and yolk) are mixed with 100 ml of the full fat milk above, and cooked in a non-stick pan (no fat). The eggs are stirred continuously until cooked but still slightly runny. (3) Add the remaining 40 ml full fat milk. (4) Put egg into a bowl then blend until smooth, with no signs of going lumpy, using the hand blender on highest setting. (5) Dip each metal slide into the scrambled egg and tap once, ensure that there is approximately the same amount of egg on each slide. The backs of the slides are wiped on a tissue to clean and placed on an oven rack. (6) Soiled slides are placed on 2 oven racks in numerical order. (7) The slides are left to dry for 30 minutes at room temperature. (8) Slides are cooked for 2 hours at 80° C. (+/−1° C.), with the upper and lower shelves being swapped and rotated by 180° (+/−1° C.) after 1 hour. (9) Cooled, soiled slides are weighed in order 1-96.

Washing: Place eight stained slides both in top rack and bottom rack of the washing machine. Pre-wash and Main wash based on Whirlpool 840 cup capacity of 40 mls. for Pre-wash and 60 mls. for Main wash. Typically in one test, four products are run using four GE 500 machines. For test cycle, load the soiled slides and put test product in the Pre-wash and Main Wash cups. Set water temperatures to 120F and turn on machines to the Normal wash cycle. Take the slides out for weighting at the end of the final rinse cycle; do not go through the dry cycle. By the end of the fourth repetition each product has been run once in each machine. All four reps are to be run in one day. The next day, this same procedure is repeated using new soiled substrates. This gives a total of 8 repetitions per product, which are then averaged for the final results. Gravimetric Evaluation resulting in approximated percent removal is calculated as follows:
% Removal=(soiled weight-washed weight)/(soiled weight-clean weight)×100 Removal Index=% Removal/% Removal by Benchmark Protease (Savinase®)

The results of said performance tests are included as follows:

Scrambled Egg Removal Index vs. Protease B in ADW

| | 24 Well Test | | Full Scale Test | |
|---|---|---|---|---|
| Enzyme | Gel | Powder | Gel | Powder |
| Protease B (2.5 ppm) | 100 | 100 | 100 | 100 |
| Ovozyme (2.5 ppm) | 105 | 75 | 110 | 120 |
| Esperase (2.5 ppm) | 106 | 99 | 111 | 108 |
| Protease B + Ovozyme(1.25 ppm + | 144 | 134 | 141 | 123 |
| 1.25 ppm) | | | | |
| Protease B + Esperase(1.25 ppm + | 158 | 109 | 112 | 169 |
| 1.25 ppm) | | | | |
| Protease B + Phospholipase C | 160 | 148 | 107** | 111 |

**equivalent to +2 PSU benefit in visual grading evaluation.

Scrambled Egg Removal in Hand Dish Wash Detergent by 24 Well (Micro Screening)

| Enzyme | Gel | Powder |
|---|---|---|
| Protease A (0.9 ppm) | 100 | 100 |
| Ovozyme (0.3 ppm) | 33 | 107 |
| Protease A (0.1 ppm) + Ovozyme (0.25 ppm) | 39 | 140 |
| Protease A (0.3 ppm) + Ovozyme (0.1 ppm) | 44 | 141 |
| Protease A (0.2 ppm) + Ovozyme (0.2 ppm) | 44 | 121 |

Significant increase in removal versus Protease A was determined even at lower total protein level in cocktail application.

### EX3: Identification of Enzyme Cocktail (protease, lipase, hemicellulase-one of carbohydrases) for Improved Grass Cleaning Versus Protease A Benchmark in HDL Detergent

It was observed that the combination of Protease A and Lipase shows approximately 0.5 Panel Score Units (PSU) benefits vs. Protease A. The PSU grading systems are used to compare two products (formulas), say A and B. The two formulas are tested on performance, e.g. post wash stain residuals. In such an experiment several fabrics, washed with both A and B, are compared. Two or more judges do the grading where they use the so-called Schelle scale:

### 0: No preference

### 1: I think this product is a little better (unsure)

### 2: I know this product is a little better

### 3: This product is better

### 4: This product is much better

Protease (Protease A) Dose response in Grass Cleaning in Liquid Tide Low Temperature Wash—4 PSU Benefit by High Level of Protease

| | | B (1 × | C (10 × | D (10 × | |
|---|---|---|---|---|---|
| | | Protease | Protease | Protease A + 10 ppm | |
| | A (nil) | A) | A) | Lipase | LSD 90 |
| Grass CW | 0 | 1.71 | 3.32 | 3.82 | 1.18 |
| 120 | | | | | |

Mini-washer test: 12 minute wash, 60 F wash temperature. Product concentration 1532 ppm in wash, 8 gpg hardness (city water). CW Grass stained fabrics were obtained from Empirical Manufacturing Company, Ohio, USA.

Further, combination of protease and carbohydrase shows significantly increased benefits in grass cleaning as shown below:

Full scale washing machine (PSU) versus Liquid Tide Control:

| Enzymes versus | nil-Enzyme |
|---|---|
| Pectate Lyase 2 ppm | 2.5 PSU |
| Protease A 0.59 ppm | 2 PSU |
| Pectate Lyase 2 ppm + Protease A 0.59 ppm | 4 PSU |
| Pectate Lyase/Xyloglucanase 2 ppm + Protease A 0.59 ppm | 4 PSU |

Full scale washing machine test were done at 6 gpg hardness, US washing condition.

### EX 4: Detergent Compositions Comprising Enzyme Cocktails for Removal of Egg-based Stains and/or Soils

The following fully-formulated solid form automatic dishwashing detergents were prepared for the removal of egg-based stains and/or soils in accordance with the present invention:

| | 1 | 2 | 3 |
|---|---|---|---|
| | % Active | % Active | % Active |
| Sodium Citrate | 15 | 15 | 15 |
| Sodium Carbonate | 17.5 | 20 | 20 |
| Dispersant Polymer | 6.0 | 6.0 | 6.0 |
| Hydroxyethyldiphosphonate (HEDP; | 1.0 | 0.5 | 0.71 |
| acid) | | | |
| Nonionic Surfactant (SLF18; | 2.0 | 2.0 | 2.0 |
| Olin Corp.) | | | |
| Sodium Percarbonate | 1.5 | 1.5 | 1.5 |
| Monohydrate | | | |
| Ovozyme 24T (protease) | — | 1.1 | — |
| Protease B | — | — | 1.1 |
| Cobalt Catalyst | 0.2 | 0.07 | 0.4 |
| Esperase 80L (protease) | 1.1 | — | 1.1 |
| Savinase 12T (protease) | 1.1 | 1.1 | — |
| Termamyl 60T (amylase) | 1.5 | 1.0 | 1.0 |
| Phospholipase C | 2.0 | 2.0 | 2.0 |
| BRITESEL H₂O₂ (as SiO₂) | 8.0 | 8.0 | 8.0 |
| Meta Silicate (anhydrous) | 1.25 | — | — |
| Parafin | 0.5 | — | — |
| Benzotriazole | 0.3 | — | — |
| Sulfate, water, minors | Balance | Balance | Balance |
| | to 100% | to 100% | to 100% |

### EX5: Detergent Composition Comprising Enzyme Cocktails for Removal of Grass-based Stains and/or Soils

The following liquid detergent compositions are prepared in accordance with the present invention for the removal of grass-based stains and/or soils

% by weight of the detergent compositions

| | A | B | C | D | E |
|---|---|---|---|---|---|
| Lineair alkylbenzene sulfonate | 18 | — | — | — | — |
| C₁₂-C₁₅ Alkyl ethoxylated sulfate | — | 2 | 8 | 11 | 5 |
| C₈-C₁₀ propyl dimethyl amine | 2 | 2 | 2 | 2 | 1 |
| C₁₂-C₁₄ alkyldimethyl amine oxide | — | — | — | — | 2 |
| C₁₂-C₁₅ Alkyl sulfate | 17 | 12 | 7 | 8 | |
| C₁₂-C₁₄ N-methyl glucamide | — | 5 | 4 | 4 | 3 |
| C₁₂-C₁₄ fatty alcohol ethoxylate | 12 | 6 | 1 | 1 | 1 |
| C₁₂-C₁₈ Fatty acid | 11 | 11 | 4 | 4 | 3 |
| Citric acid anhydrous | 5 | 1 | 3 | 3 | 2 |
| Diethylene triamine penta | | | | | |
| methylene phosphonic acid | 1 | 1 | 1 | 1 | 0.5 |
| Monoethanolamine | 11 | 8 | 5 | 5 | 2 |
| Sodium hydroxide | 1 | 1 | 2.5 | 1 | 1.5 |
| Propanediol | 12.7 | 14.5 | 13.1 | 10.0 | 8 |
| Ethanol | 1.8 | 1.8 | 4.7 | 5.4 | 1 |
| Pectate Lyase (3 g/l) | 0.05 | — | — | 0.05 | — |
| Lipase (5 g/l) | 0.1 | 0.1 | 0.1 | 0.1 | 0.1 |
| Protease A (34 g/l) | 0.5 | 0.5 | 0.5 | 0.5 | 0.5 |
| Xyloglucanase (2 g/l) | — | 0.09 | — | — | 0.09 |
| Carezyme (3 g/l) | — | — | 0.05 | — | — |
| Terephthalate-based polymer | 0.5 | 0.5 | — | 0.3 | 0.3 |
| Boric acid | 2.4 | 2.4 | 2.8 | 2.8 | 2.4 |
| Sodium xylene sulfonate | — | — | 3 | — | — |
| DC 3225C | 1 | 1 | 1 | 1 | 1 |
| 2-butyl-octanol | 0.03 | 0.04 | 0.04 | 0.03 | 0.03 |
| Branched silicone | 0.3 | 0.3 | 0.3 | 0.3 | 0.3 |

All documents cited are, in relevant part, incorporated herein by reference; the citation of any document herein is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of formulating an enzyme cocktail, said method comprising the steps of:
(a) identifying a stain and/or soil for which removal via enzyme hydrolysis is sought;
(b) examining the stain and/or to determine a level of presence of each enzyme-hydrolysable component of said stain and/or soil;
(c) screening multiple enzymes to determine which enzyme demonstrates a highest activity against each enzyme-hydrolysable component in said stain and/or soil; and
(d) incorporating one or more enzymes demonstrating the highest activity against each enzyme-hydrolysable component in said stain and/or soil into said cocktail;
(e) optionally, incorporating one or more enzymes demonstrating the highest activity against each enzyme-hydrolysable component in said stain and/or soil in an amount corresponding to the level of presence of said enzyme-hydrolysable component in said stain and/or soil.

2. A protease cocktail for removing a protein-comprising stain and/or soil, said cocktail comprising one or more enzymes adapted to remove one or more proteins present in said stain and/or; wherein said enzymes are incorporated into said cocktail in an amount corresponding to the content of a target protein in said stain and/or soil.

3. A carbohydrase cocktail for removing a carbohydrate-comprising stain and/or soil, said cocktail comprising one or more enzymes adapted to remove one or more carbohydrates present in said stain and/or soil; wherein said enzymes are incorporated into said cocktail in an amount corresponding to the content of a target carbohydrate in said stain and/or.

4. A lipase cocktail for removing a lipid-comprising stain and/or soil, said cocktail comprising one or more enzymes adapted to remove one or more lipids present in said stain and/or soil; wherein said enzymes are incorporated into said cocktail in an amount corresponding to the content of a target lipid in said stain and/or soil.

5. A phospholipase cocktail for removing phospholipid-comprising stain and/or soil, said cocktail comprising one or more enzymes adapted to remove one or more phospholipids present in said stain and/or soil; wherein said enzymes are incorporated into said cocktail in an amount corresponding to the content of a target phospholipid in said stain and/or soil.

6. An enzyme cocktail for removing protein-comprising, carbohydrate-comprising, lipid-comprising and phospholipid-comprising stains and/or soils, said cocktail comprising a cocktail selected from the group consisting of: the protease cocktail according to claim 2, the carbohydrase cocktail according to claim 3, the lipase cocktail according to claim 4, the phospholipase cocktail according to claim 5 and combinations thereof.

7. A detergent composition comprising a cocktail selected from the group consisting of: the protease cocktail according to claim 2, the carbohydrase cocktail according to claim 3, the lipase cocktail according to claim 4, the phospholipase cocktail according to claim 5, the enzyme cocktail according to claim 6 and combinations thereof.

8. A protease cocktail for removing an egg-based stain and/or soil, said cocktail comprising at least two proteases selected from the group consisting of:
(a) a protease adapted to hydrolyze casein at a rate of at least about 0.1% proteolytic activity per mg of active protein, of an enzyme standard;
(b) a protease adapted to hydrolyze phosvitin and/or lipovitellin at a rate of at least about 0.1% proteolytic activity per mg of active protein, of an enzyme standard;
(c) a protease adapted to hydrolyze ovalbumin at a rate of at least about 0.1% proteolytic activity per mg of active protein, of an enzyme standard; and
(d) combinations thereof;
wherein a ratio between any two of said proteases is from about 1000:1 to about 1:1000, based on a weight of active protein.

9. An enzyme cocktail for removing an egg-based stain and/or soil, said cocktail comprising:
(a) a lipase adapted to hydrolyze triglyceride and/or diglyceride at a rate of at least about 0.1% activity per mg of active protein, of an enzyme standard;
(b) a phospholipase adapted to hydrolyze phosphatidyl choline or lysophosphatidyl choline at a rate of at least about 0.1% activity per mg of active protein, of an enzyme standard; and
(c) optionally, the protease cocktail of claim 8;
wherein a ratio between any two of said enzymes is from about 1000:1 to about 1:1000, based on a weight of active protein.

10. A protease cocktail for removing a grass-based stain and/or soil, said cocktail comprising:
(a) a protease adapted to hydrolyze D-ribulose 1,5-diphosphate carboxylase at a rate of at least about 0.1% proteolytic activity per mg of active protein, of an enzyme standard;
(b) a protease adapted to hydrolyze one or more chlorophyll-binding proteins at a rate of at least about 0.1% proteolytic activity per mg of active protein, of an enzyme standard; and
(c) a protease adapted to hydrolyze ATP synthase at a rate of at least about 0.1% proteolytic activity per mg of active protein, of an enzyme standard;
wherein a ratio between any two of said proteases is from about 1000:1 to about 1:1000, based on a weight of active protein;
wherein said chlorophyll-binding proteins are selected from the group consisting of CP47, CP43, CP29, CP27, CP24 and combinations thereof.

11. An enzyme cocktail for removing a grass-based stain and/or soil, said cocktail comprising:
(a) a lipase adapted to hydrolyze triglyceride and/or diglyceride at a rate of at least about 0.1% activity per mg of active protein, of an enzyme standard;
(b) a pectinase adapted to hydrolyze poly-D-galacturonic acid methyl ester at a rate of at least about 0.1% activity per mg of active protein, of an enzyme standard;
(c) a hemicellulase adapted to hydrolyze hemicellulose, xyloglucans, xylans and combinations thereof at a rate of at least about 0.1% activity per mg of active protein, of an enzyme standard;
(d) a cellulase adapted to hydrolyze cellulose and/or carboxy methyl cellulose at a rate of at least about 0.1% activity per mg of active protein, of an enzyme standard; and
(e) optionally, the protease cocktail of claim 10;
wherein a ratio between any two of said enzymes is from about 1000:1 to about 1:1000, based on a weight of active protein.

12. A detergent composition comprising the protease cocktail according to claim 8, wherein said protease cocktail is present at a level of from about 0.00001% to about 5% by weight of pure active protein of said protease cocktail, based on the total weight of said detergent composition.

13. A detergent composition comprising the protease cocktail according to claim 10, wherein said protease cocktail is present at a level of from about 0.00001% to about 5% by weight of pure active protein of said protease cocktail, based on the total weight of said detergent composition.

14. A detergent composition comprising the protease cocktail according to claim 8 and the protease cocktail according to claim 10, wherein said protease cocktails are present at a level of from about 0.00001% to about 5% by weight of pure active protein of said protease cocktail, based on the total weight of said detergent composition

15. A detergent composition comprising the enzyme cocktail according to claim 9, wherein said cocktail is present at a level of from about 0.00001% to about 5% by weight of pure active enzyme of said cocktail, based on the total weight of said detergent composition.

16. A detergent composition comprising the enzyme cocktail according to claim 11, wherein said cocktail is present at a level of from about 0.00001% to about 5% by weight of pure active enzyme of said cocktail, based on the total weight of said detergent composition.

17. A detergent composition comprising the enzyme cocktail according to claim 9 and the enzyme cocktail according to claim 11;
wherein said cocktails are present at a level of from about 0.00001% to about 5% by weight of pure active enzyme of said cocktails, based on the total weight of said detergent composition.
